(19) United States
(12) Patent Application Publication
(10) Pub. No.: US 2025/0043672 A1
(43) Pub. Date: Feb. 6, 2025

(54) Comprehensive Enerty Systems

(71) Applicant: GTherm Energy, Inc., Houston, TX (US)

(72) Inventor: Michael J. Parrella, Katy, TX (US)

(21) Appl. No.: 18/719,210

(22) PCT Filed: Dec. 13, 2022
(86) PCT No.: PCT/US2022/081436

§ 371 Date: Jun. 12, 2024

Related U.S. Application Data
(60) Provisional application No. 63/288,946, filed on Dec. 13, 2021.

(51) Int. Cl. E21B 43/40; A01G 7/02; B01D 53/14; B28C 9/00; C10L 1/32; C25B 9/65; E21B 43/16; E21B 43/24; F01D 15/10

(52) U.S. Cl. CPC E21B 43/40; A01G 7/02; B01D 53/1475; B28C 9/00; C10L 1/328; C25B 9/65; E21B 43/164; E21B 43/24; F01D 15/10; B01D 2256/10; B01D 2256/12; B01D 2256/22; B01D 2257/504; F05D 2220/76

(57) ABSTRACT

A system and method for comprehensive energy recovery and utilization in energy intensive processes is provided. The system comprises a hydrocarbon production system configured to recover hydrocarbons from an underground reservoir; an electricity generation system comprising one or more turbines configured to generate electricity and heated turbine exhaust gases; a heat exchanger configured to receive the heated turbine exhaust gases from the one or more turbines and transfer heat from the heated turbine exhaust gases to a fluid, and configured to output a heated fluid and cooled turbine exhaust gases; a gas separator configured to receive the cooled turbine exhaust gases and separate gases in the cooled turbine exhaust gases; and a fuel source configured to provide hydrocarbon fuel or thermal energy for powering the one or more turbines of the electricity generation system.

### CROSS-REFERENCE TO RELATED APPLICATIONS

The present application claims the benefit of U.S. Provisional Patent Application 63/288,946, filed Dec. 13, 2021, which is incorporated by reference in its entirety.

### FIELD OF THE APPLICATION

The present application relates to a comprehensive energy system for energy intensive applications.

### BACKGROUND OF THE DISCLOSURE

Energy intensive businesses are businesses that consume a substantial amount of energy. Energy intensive manufacturing businesses include: cement; food, beverage, and tobacco product manufacturing; pulp and paper; basic chemicals, inorganic chemicals, organic chemicals (e.g., ethylene propylene), resins, and agricultural chemicals including chemical feedstocks; petroleum refining; iron and steel; nonferrous metals (primarily aluminum and other nonferrous metals, such as copper, zinc, and tin); and nonmetallic minerals (primarily other nonmetallic minerals, such as glass, lime, gypsum, and clay). Energy intensive non-manufacturing industries include agriculture; forestry; fishing; mining; and natural gas extraction.

Energy intensive manufacturing may use several fuel sources, including coal, liquids, natural gas, electricity, and renewables, and the energy consumption by energy intensive manufacturing has steadily increased and is projected to continue increasing. Among energy intensive manufacturing industries, the cement industry is the most energy intensive of manufacturing industries. Fuels currently used in cement manufacturing include coal/coke and a limited amount of gas and oil, and for many years, world-wide, waste-derived fuels have been used to partially replace fuels in cement manufacture. Temperatures during cement manufacturing range from 1450° C. to 2700° C.

The present application incorporates enhanced, comprehensive energy systems with energy intensive manufacturing to provide an energy efficient and reduced emissions system. Certain enhanced oil recovery systems combining oil and gas recovery with electricity generation are known in the art, particularly from applicant's earlier U.S. Pat. No. 10,443,364 (application Ser. No. 15/517,602 filed Apr. 7, 2017), which is hereby incorporated by reference in its entirety. As background, several examples of such systems are summarized below.

FIG. 1a shows an energy recovery system and method according to the prior art. One or more oil wells 102 are pumped to produce a fluid mixture 104 that may include crude oil, natural gas, and brine. The pumped fluid is provided to a separator 106, a pressure vessel that separates the different well fluids into their constituent components of oil, gas and water/brine and that provides separate flows of crude oil 108, brine 110, and natural gas 112. Separators work on the principle that the three components have different densities, which allows them to stratify when moving slowly with gas on top, water and solids on the bottom and oil in the middle. If there are more than one well used and the volume of recovered hydrocarbons is large, a plurality of heat sources may be employed in the system, as in FIG. 1a. In such a case, the natural gas may be provided from an outlet of the separator to an inlet of a manifold 114 and split by the manifold 114 into a plurality of natural gas stream outlets provided in piping connected to the plurality of heat sources, in this case, one or more “green boilers” 118. Other types of heat sources such as furnaces may be used as well. It should be realized that some 109 of the crude oil 108 separated by the separator 106 may be used to fuel the heat source either alone or in combination with natural gas. There are boilers that can burn both types of fuel. If in some cases the hydrocarbon recovery volume is low and additional fuel is needed, e.g., crude oil and/or diesel 120, it may be supplied 122 via another manifold 124 to the plurality of heat sources via separate fuel feed pipelines 126. In any event, the system of FIG. 1a carries out a method of burning crude oil and/or natural gas extracted from an underground reservoir for providing thermal energy.

Natural gas 116 supplied by the manifold 114 may also be supplied to gas, crude oil, or diesel fueled heat engines such as a gas turbine generator 127 that provides electricity 128. The electricity output from the generator 127 may be connected to an electric resistant cable that is used to produce heat for heating a thermally assisted oil well, or may be used for other purposes. The separated brine 110 from the separator 106 may be provided to a heat exchanger/mixer 130 to be heated. Thermal energy may be transferred from the boilers 118 to a fluid such as water circulating in a closed loop through the boilers and the heat exchanger. Heated water is shown being provided on one or more pipelines 119 from outlets of the boilers 118 to at least one inlet of a hot water manifold 121. An outlet of the hot water manifold provides hot water on a line 123 to an inlet of a heat exchanger part of the heat exchanger/mixer 130 or to a separate heat exchanger.

Hot exhaust gases from the one or more heat engines such as exhaust 129 from the gas boilers 118 and/or exhaust gases 131 from a gas turbine of the turbine generator 127 are provided to an exhaust scrubber 132. Scrubbed exhaust gases 133, containing CO₂ and N₂ for example, are then provided to the mixer part of the heat exchanger/mixer 130 or to a separate mixer. The mixer performs a mixing of the scrubber exhaust gas 133 from the scrubber 132 (fed by at least one of a heating vessel, e.g., boiler(s) 118 and a heat engine e.g. a turbine of turbine generator 127) with the separated brine at least before, during, or after the transfer of thermal energy to the separated brine, wherein hot brine 140 mixed with the exhaust gas 133 is injected into the underground reservoir via one or more injection wells. The fluids to be mixed are fed at one end of a mixer and the internal elements of the mixer impart flow division to promote radial mixing while flowing toward the other end. Simultaneous heating can be done if the mixer is inside the heat exchanger.

The heat exchanger 130 transfers thermal energy produced in the boilers 118 to the brine 110, for providing heated brine 140, and/or for converting the thermal energy to mechanical work for instance by a turbine generator 127. The system of FIG. 1a then continues the process by heating the underground reservoir with the heated brine on the line 140 by injecting it into the underground reservoir.; and/or by heating the underground reservoir with a resistive cable energized by electricity 128 generated by converting mechanical work to electric energy.

Cooled circulating water 150 from an outlet of the heat exchanger/mixer 130 is returned to the boilers 118 for re-heating and for again being fed into the hot water manifold 121 on lines 119 for heating more brine produced on an on-going basis by the wells 102. Geothermal heat 191 may be supplied to the hot water manifold 121. Hot water 171, 181 from the hot water manifold 121 may be further provided to provide heat for a thermally assisted oil well 170, or to other applications 180 requiring heat. The cooled water from these applications can be fed into the cooled circulating water 150 by way of separate lines 172 or 182. It should be mentioned that if viscosity reducing additives are used for instance as shown on a line 160 for mixture in a mixer (not shown) with the extracted brine 110, there will need to be an additive separator (also not shown) as signified by the brine 162 being sent to such an additive separator before it is returned 110a to the heat exchanger/mixer 130. One or more producer wells 203 deliver oil, gases and brine (water) on a line 205 (which may contain other elements) to at least one separator 206. The at least one separator 206 separates the oil and provides separated oil 207, provides separated gas 204, and provides separated brine 208. The separated brine may include optional additives and/or optional oil. The separated brine with or without the optional additives and/or crude oil is sent to an inlet of at least one heat exchanger/mixer 214. If additives have been used, they are separated from the brine. The oil 207 (less any oil used for fluid injection 208 and any oil that may be used for thermal generation) is sent to a pipeline or a storage tank as recovered crude oil. The gas 204 and/or any oil used for thermal generation is sent to one or more boilers 221 for generation of thermal energy and may also be sent to one or more heat engines connected to an electric generator, such as one or more turbine generators 220 for generation of electricity 209. A further gas or crude oil source 222 may provide gas and/or crude oil into the line 204. The turbines of the one or more turbine generators 220 may be gas turbines, which deriver power from burning fuel such as the gas or crude oil in a combustion chamber and using the fast flowing combustion gases to drive a turbine in a manner similar to the way high pressure steam drives a steam turbine. The difference is that the gas turbine has a second turbine acting as an air compressor mounted on the same shaft. The air turbine draws in and compresses air, and feeds the air at high pressure into the combustion chamber to increase the intensity of the burning flame. The pressure ratio between the air inlet and the exhaust outlet is maximized to maximize air flow through the turbine. High pressure hot gases are sent into the gas turbine to spin the turbine shaft at a high speed connected via a reduction gear to the generator shaft. In the alternative, the one or more turbine generators 220 may include one or more steam turbines, and the one or more boilers 221 may include one or more steam boilers; or exhaust gases from a gas turbine may be supplied to a heat exchanger that produces steam fed to a steam turbine connected to another electric generator.

Exhaust 211 from the boiler(s) 221 the turbine generator 220 is sent to an inlet of the heat exchanger/mixer 214. The hot water 212 from the closed loop boiler 221 and the cooled water 213 from the heat exchanger/mixer 214 are cycled. The hot water 212 from the boiler 221 is provided to another inlet of the heat exchanger/mixer 214. The heat exchanger/mixer 214 uses the heat from hot water 212 to heat the brine or brine/oil mixture 208 before, during, or after mixing the brine or brine-oil mixture with the exhaust 211. The mixer 214 mixes the exhaust into the brine or brine-oil mixture before, during, or after the heat transfer. Once the heat exchange has occurred the cooled water 213 is sent from the heat exchanger 214 to the boiler 221 for re-heating.

The heated brine/oil mixture 217 may be mixed with the heated exhaust 216 and then optionally mixed with additional additives 215 and sent to one or more injection pumps 218. The injection pumps 218 inject the combined mixture into one or more injection wells 201, and may include one or more oscillating devices that create pressure waves for the oil extraction system. The injection wells 201 inject heated brine and/or oil, hot exhaust gases such as CO₂, N₂ and other gases, and optionally additives into the oil and gas reservoir. Electricity 209 for the injection pump or pumps may be provided by the electric generator of the turbine generator 220.

The heat delivery well 202 radiates heat into the reservoir using either electricity generated from the generator of the turbine generator 220 (as shown) and/or water heated by the boiler 221 and circulated in a closed loop (see, e.g., FIG. 1c into and out of a heat delivery well 302b).

One or more producer well pumps pulsing oscillators 219, and electric heating cables 210 may be powered by the generator of the turbine generator 220. The one or more pulsing oscillators 219 are used to stimulate the underground reservoir with additional pressure waves 203a that are propagated into the underground reservoir. The oil, gas, and brine mixture in a given production well 203 is stimulated during extraction from underground. The additional pressure waves 203a are controlled such that the additional pressure waves 203a are at the same frequency and are synchronized to propagate “in phase” with the pressure waves 201a that are separately propagated into the underground reservoir by stimulation of the heated brine during injection into the well 201. When the “in phase” pressure waves 203a meet the pressure waves 201a in the reservoir between the two wells, they interfere constructively. One or more monitor wells 223 may be employed to provide control information to a control system.

FIG. 1c shows another embodiment where the fluid heated in a boiler 321 is circulated in a closed loop above ground to and from a heat exchanger/mixer 314, and below ground in a heat delivery well 302b in an underground oil/gas/brine reservoir 301. It should be realized that the heat delivery well 302b may be fed circulating hot fluid 312b by the boiler 321, by a separate boiler, or by another type of heat source. Wavy arrows 302 are shown emanating from the heat delivery well 302b in the reservoir 301 to signify the transfer of heat to the oil/gas/brine reservoir 301. Oil, gas, and brine produced from one or more production wells 303 is provided on a line 305b to at least separator 306 that provides separated gas on a line 304 to the boiler 321, separated oil on a line 307 for storage, and separated brine 308 to the heat exchanger/mixer 314. Hot exhaust 311 from the boiler 321 is provided to a mixer part of the heat exchanger/mixer 314 for mixing with the separated brine 308. The hot brine/exhaust mixture is injected into an injection well 317, where hot brine flooding takes place to heat the reservoir, displace the trapped hydrocarbons, and push or move the hydrocarbons toward the one or more production wells 303. Wavy arrows 320, 330 are shown emanating from the hot brine flooding well 317 into the reservoir 301 to signify the delivery of hot brine/CO₂ to heat the oil/gas/brine reservoir 301 and to push and displace gas and oil toward the one or more production wells 303. Hot water from the boiler 321 is provided on a line 312a to the heat exchanger 314 where it transfers heat to the separated brine 308. The cooled fluid emerging from the heat exchanger on a line 313a may be joined with cooled fluid 313b emerging from the heat delivery well 302b before the joined fluids 313c are together returned to the boiler 321 for re-heating. The re-heated fluid 312a, 312b emerges from the boiler 321 for connection to the heat exchanger 314 for connection to the heat delivery well 302b in a repeating cycle of heating, cooling, and re-heating.

Also shown in FIG. 1c, pressure waves 303a may be generated in both the one or more production wells 303 and additional pressure waves 317a in the at least one injection well 317. The underground placement of the production and injection wells with respect to each other may be set up such that constructive interference is facilitated and controlled so the production and injection waves stimulate the reservoir simultaneously, continuously and are synchronized in phase so as to meet in the reservoir and add constructively, to increase the amplitude of the stimulating force imparted to the reservoir. At least part of the production wave 303a is propagated in a direction toward the injection well 317 and the injection wave 317a is propagated in the opposite direction toward the production well 303, and the waves meet in between the wells.

FIG. 1d shows a further embodiment of an enhanced oil recovery system. The system comprises injection wells 380, heat delivery wells 381, monitor wells 382 and producer wells 383. The production well 383 pumps oil, gas, brine and/or water 352. The production well 383 is equipped with an oscillator 368a and a jet pump 373, which aid in generating the pressure waves 385 that are used to increase oil recovery in the reservoir. A manifold 374a is also provided between the production well and a separator 353. The separator 353 separates the brine 351, gas 354 and the oil 355.

A boiler and steam turbine or generator 360 is provided with oxygen from an oxygen/nitrogen separator 358, and is provided with the separated oil 354 and with methane/Carbon Dioxide (CH₄/CO₂) 357 from a carbon dioxide/methane separator 356, receiving the separated gas 354. Using these components, the boiler 360 convert water from the steam turbine 362 into steam 361 and generates electricity for operations 364, electricity for sale on the energy market 384, and supplies electricity 365 to an electric heating cable 366 in the production well 383. CO2 359 from the oxygen/nitrogen separator 358 can also be added to the inlet flow to the boiler 360 as needed to control flame temperature without adding N₂ to the exhaust stream.

The exhaust of the boiler and steam turbine or generator 360 is provided to one or more heat exchangers 390 configured to heat water and/or brine. Separated brine 351 is mixed with water and additives 393 and pumped by a pump 392a to a heat exchanger 390, which heats the brine and outputs heated brine 370 to the injection well 380. Carbon dioxide 359, separated by the separator 356, is mixed with hot exhaust 363 from the heat exchanger 390, and compressed by a compressor 391. The compressed and heated CO₂ and exhaust gases 367 are supplied to a manifold 374b, and pumped into the injection well 380, which also incorporates an oscillator 368b to aid in creating pulsing pressure waves 385.

The heat delivery well 381 is provided with a manifold 374c. The heat delivery well 381 pumps via a pump 392b cooled water 372 to a heat exchanger 390, which outputs heated water 371. The heated water 371 is provided to the heat delivery well 381 to transfer heat into the well. As the heated water 371 transfers heat to the well, the water cools and the cooled water 372 is provided back to the heat exchanger 390 in a cyclical manner.

The present application provides for systems in which oil recovery systems such as those described above, are modified and expanded to allow to incorporate other systems and processes such as manufacturing, crop stimulation, and the provision of electricity to external facilities otherwise independent from the comprehensive energy system.

### SUMMARY OF THE DISCLOSURE

The present application relates to a comprehensive energy system for energy intensive manufacturing processes. The systems of the present application minimize electricity costs and allow for the capture, absorption, and sequestration of generated carbon dioxide (CO₂). Fuel options with the systems include coal, coke, oil/liquids, natural gas, hydrogen, and municipal waste (waste to energy). Tax advantages of the system in the United States include CO₂ sequestration credits, CO₂ absorption credits, depreciation, depletion allowance, and R & D credits.

The comprehensive energy systems described herein can be used in a variety of applications, including in energy intensive manufacturing and cement manufacturing, and may utilize a variety of fuel sources, such as oil and gas, refuse, and coal or coke. Use of the comprehensive energy systems described herein, which repurpose waste heat and waste emissions from burning fuel source, in connection with energy intensive manufacturing or cement manufacturing results in a reduction of electricity use and in emissions, and allows for the generation of electricity and gases that may have separate uses, such as powering other facilities like data centers or providing carbon dioxide and nitrogen for crop stimulation.

In accordance with a first aspect of the present application, a system is provided. The system comprises a hydrocarbon production system configured to recover hydrocarbons from an underground reservoir; an electricity generation system comprising one or more turbines configured to generate electricity and heated turbine exhaust gases; a heat exchanger configured to receive the heated turbine exhaust gases from the one or more turbines and transfer heat from the heated turbine exhaust gases to a fluid, and configured to output a heated fluid and cooled turbine exhaust gases; a gas separator configured to receive the cooled turbine exhaust gases and separate gases in the cooled turbine exhaust gases; and a fuel source configured to provide hydrocarbon fuel or thermal energy for powering the one or more turbines of the electricity generation system.

Implementations of the system of the first aspect of the present application may include one or more of the following features, separately or in combination. The hydrocarbon production system may include one or more production wells configured to recover the hydrocarbons from the underground reservoir, and the hydrocarbons recovered by the one or more production wells may include oil and/or natural gas. The one or more production wells are further configured to recover brine from the underground reservoir with the hydrocarbons recovered. The hydrocarbon production system further may include a separator configured to separate oil, natural gas and brine recovered by the one or more production wells. The separator is configured to supply separated brine to the heat exchanger. The separator may also be configured to supply separated oil to an emulsifier configured to produce emulsified oil, and the emulsified oil is provided to the one or more turbines as the fuel source. The separator may also be configured to supply separated oil to the one or more turbines as the fuel source. The hydrocarbon production system further may include: one or more heat delivery wells configured to supply a heated substance to the underground reservoir; and one or more injection wells configured to inject a gas into the underground reservoir. The heat exchanger is configured to output heated brine as the heated fluid and provide the heated brine to the one or more heat delivery wells configured to supply the heated brine to the underground reservoir. The gas separator is configured to separate carbon dioxide from the cooled turbine exhaust gases and provide at least a portion of the separated carbon dioxide to the one or more injection wells configured to inject the separated carbon dioxide into the underground reservoir.

The electricity generation system may be configured to provide electricity for powering electrical components of the hydrocarbon production system; and/or to provide electricity to a grid or an external facility, such as a data center consuming the electricity; and/or to provide electricity to power an electrolysis device of a hydrogen generation system, the electrolysis device configured to subject water to an electrolysis process to create hydrogen and oxygen. The gas separator may be configured to separate oxygen gas from the cooled turbine exhaust gases; and provide at least a portion of the separated oxygen gas to the one or more turbines.

The electricity generation system can be further configured to provide electricity to a crop or plant growth system. The gas separator can be configured to separate oxygen gas, carbon dioxide gas, and nitrogen gas from the cooled turbine exhaust gases; and provide at least a portion of the separated carbon dioxide gas and separated nitrogen gas to the crop or plant growth system for stimulation of crop or plant growth. The crop or plant growth system may be a greenhouse.

In various embodiments of the system of the first aspect of the present application, the fuel source may include an external combustion system configured to burn a fuel input to provide thermal energy for powering the one or more turbines of the electricity generating system. The external combustion system is further configured to provide heated exhaust gas to the one or more turbines and/or the heat exchanger. The one or more turbines can be steam powered turbines; and the external combustion system may include a furnace or burner configured to combust biomass waste as the fuel input and provides thermal energy from the biomass waste combustion to the one or more turbines for heating fluid to generate steam for the one or more turbine, and may further provide heated waste exhaust gases to the heat exchanger for the transfer of heat from the heated waste exhaust gases to the fluid, and/or to the one or more turbines for heating fluid to generate steam for the one or more turbines. The furnace or burner configured to combust the biomass waste can be a furnace or burner used in a manufacturing process at the manufacturing facility; and the electricity generation system is configured to generate electricity supplied to the manufacturing facility. The furnace or burner can also a kiln configured to combust the biomass waste in the generation of cement by a cement manufacturing facility; and where the electricity generation system is configured to generate electricity supplied to the cement manufacturing facility.

The external combustion system may include a furnace or burner configured to combust one or more of coal, coke, or natural gas as the fuel input and provide thermal energy from the external combustion system to the one or more turbines for heating fluid to generate steam for the one or more turbines and heated combustion exhaust gases to the heat exchanger for the transfer of heat from the heated combustion exhaust gases to the fluid, and/or to the one or more turbines for heating fluid to generate steam for the one or more turbines. The furnace or burner configured to combust the coal, coke, or natural gas can be a furnace or burner used in a manufacturing process at the manufacturing facility; and where the electricity generation system is configured to generate electricity supplied to the manufacturing facility. The furnace or burner can also be a kiln configured to combust coal, coke, or natural gas in the generation of cement at a cement manufacturing facility; and the electricity generation system is configured to generate electricity supplied to the cement manufacturing facility.

The system of the first aspect of the present application may incorporate the above-described features in various combinations, as described and shown further in the application.

In accordance with a second aspect of the present application, a method is provided, comprising: recovering hydrocarbons from an underground reservoir by a hydrocarbon production system; providing a fuel source for powering one or more turbines of an electricity generation system; generating electricity and heated turbine exhaust gases from the electricity generation system; receiving, by a heat exchanger, the heated turbine exhaust gases; transferring, by the heat exchanger, heat from the heated turbine exhaust gases to a fluid, outputting, by the heat exchanger, a heated fluid and cooled turbine exhaust gases; receiving, by a gas separator, the cooled turbine exhaust gases; and separating, by the gas separator, gases in the cooled turbine exhaust gases.

Implementations of the method of the second aspect of the present application may include one or more of the following features, separately or in combination. The hydrocarbons recovered by the hydrocarbon production system may include oil and/or natural gas, and the hydrocarbon production system further recovers brine from the underground reservoir with the hydrocarbons recovered. The method may further comprise separating oil, natural gas and brine recovered by hydrocarbon production system. The method may include supplying separated brine to the heat exchanger. The method may also include supplying separated oil to an emulsifier; producing, by the emulsifier, emulsified oil; and providing the emulsified oil to the one or more turbines as the fuel source. The method may additionally or alternatively comprise supplying separated oil to the one or more turbines as the fuel source. The method of the second aspect of the present application may comprise supplying a heated substance to the underground reservoir; and injecting a gas into the underground reservoir, wherein the method may include outputting heated brine from the heat exchanger as the heated fluid and supplying the heated brine to the underground reservoir. Separating gases in the cooled turbine exhaust gases may include separating carbon dioxide from the cooled turbine exhaust gases, and the method further may include providing at least a portion of the separated carbon dioxide for injecting into the underground reservoir.

The method of the second aspect of the present application may include providing electricity from the electricity generation system to the hydrocarbon production system, and/or providing electricity from the electricity generation system to a grid or an external facility consuming the electricity, such as a data center, and/or providing electricity from the electricity generation system an electrolysis device of a hydrogen generation system, the electrolysis device configured to subject water to an electrolysis process to create hydrogen and oxygen. Separating gases in the cooled turbine exhaust gases may include separating oxygen gas from the cooled turbine exhaust gases and the method further may include providing at least a portion of the separated oxygen gas to the one or more turbines.

In accordance with additional embodiments of the method of the second aspect of the present application, the method comprises providing electricity from the electricity generation system to a crop or plant growth system. Separating gases in the cooled turbine exhaust gases may include separating oxygen gas, carbon dioxide gas, and nitrogen gas from the cooled turbine exhaust gases; and where the method further may include providing at least a portion of the separated carbon dioxide gas and separated nitrogen gas to the crop or plant growth system for stimulation of crop or plant growth. The crop or plant growth system can be a greenhouse.

In accordance with further additional embodiments of the method of the second aspect of the present application, the fuel source may include an external combustion system, and the method further may include burning a fuel input by the external combustion system to provide thermal energy for powering the one or more turbines of the electricity generating system. The method may include providing heated exhaust gas from the external combustion system to the one or more turbines and/or the heat exchanger. The one or more turbines can be steam powered turbines; and the external combustion system may include a furnace or burner configured to combust biomass waste as the fuel input, and the method further may comprise providing thermal energy from the biomass waste combustion to the one or more turbines for heating fluid to generate steam for the one or more turbines. The method may also comprise providing heated waste exhaust gases from the biomass waste combustion to the heat exchanger for the transfer of heat from the heated waste exhaust gases to the fluid, and/or to the one or more turbines for heating fluid to generate steam for the one or more turbines. A manufacturing facility may include the external combustion system, and the furnace or burner configured to combust the biomass waste is a furnace or burner used in a manufacturing process at the manufacturing facility; and the method further may include providing electricity from the electricity generation system to the manufacturing facility. A cement manufacturing facility may include the external combustion system, and the furnace or burner can be a kiln configured to combust the biomass waste in the generation of cement; and the method further may include providing electricity from the electricity generation system to the cement manufacturing facility.

In additional or alternative embodiments of the method of the second aspect of the present application, the one or more turbines are steam powered turbines; and the external combustion system may include a furnace or burner configured to combust one or more of coal, coke, or natural gas as the fuel input and the method further may include providing thermal energy from the external combustion system to the one or more turbines for heating fluid to generate steam for the one or more turbines and heated combustion exhaust gases to the heat exchanger for the transfer of heat from the heated combustion exhaust gases to the fluid, and/or to the one or more turbines for heating fluid to generate steam for the one or more turbines. A manufacturing facility may include the external combustion system, and the furnace or burner configured to combust the coal, coke, or natural gas is a furnace or burner used in a manufacturing process at the manufacturing facility; and the method further may include providing electricity from the electricity generation system to the manufacturing facility. A cement manufacturing facility may include the external combustion system, and the furnace or burner is a kiln configured to combust coal, coke, or natural gas in the generation of cement; and the method further may include providing electricity from the electricity generation system to the cement manufacturing facility.

The method of the second aspect of the present application may incorporate the above-described features in various combinations, as described and shown further in the application.

### BRIEF DESCRIPTION OF THE DRAWINGS

FIGS. 1a-1d show embodiments of oil recovery systems according to the prior art;

FIG. 2 shows an example of a comprehensive energy system according to the present application;

FIG. 3 shows a further comprehensive energy system according to the present application;

FIG. 4 shows a further comprehensive energy system according to the present application;

FIG. 5 shows a further comprehensive energy system according to the present application;

FIG. 6 shows a further comprehensive energy system according to the present application;

FIG. 7 shows a further comprehensive energy system according to the present application; and

FIG. 8 shows a further comprehensive energy system according to the present application.

### DETAILED DESCRIPTION OF THE DRAWINGS

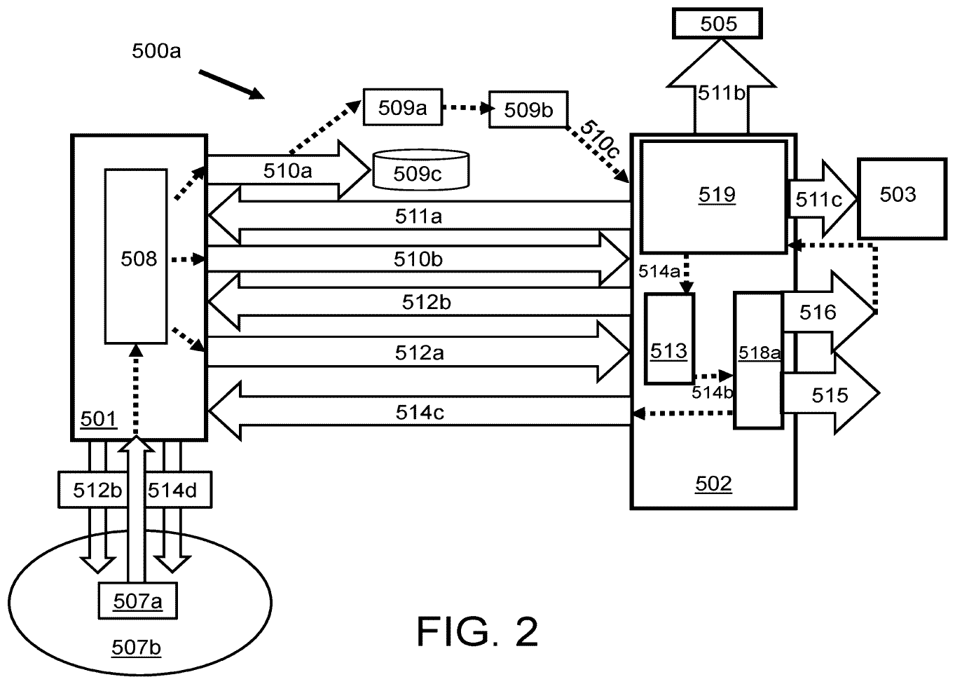

The comprehensive energy systems of the present application, and the elements and components thereof, will now be described with reference made to FIGS. 2-8.

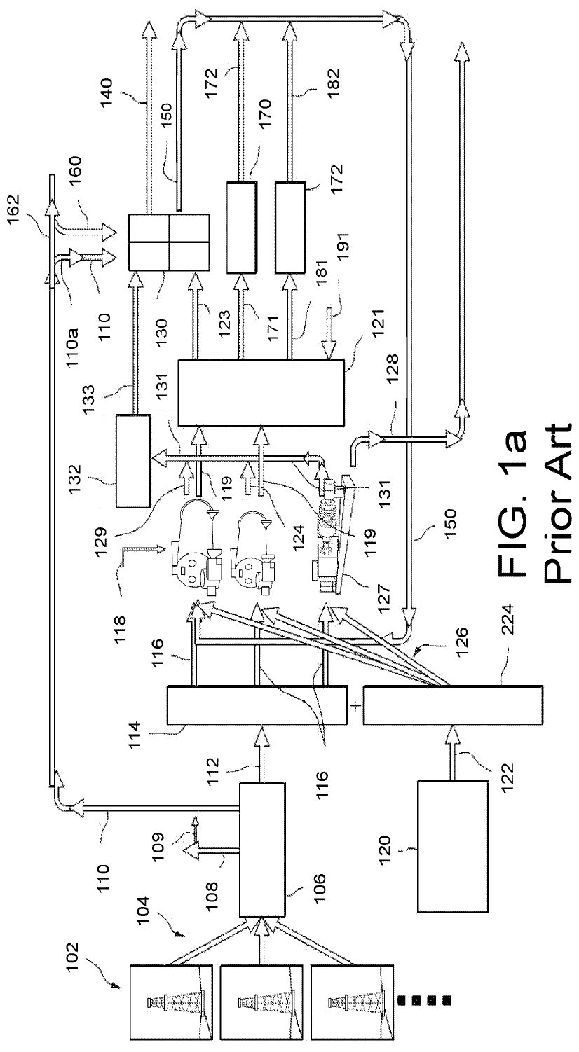

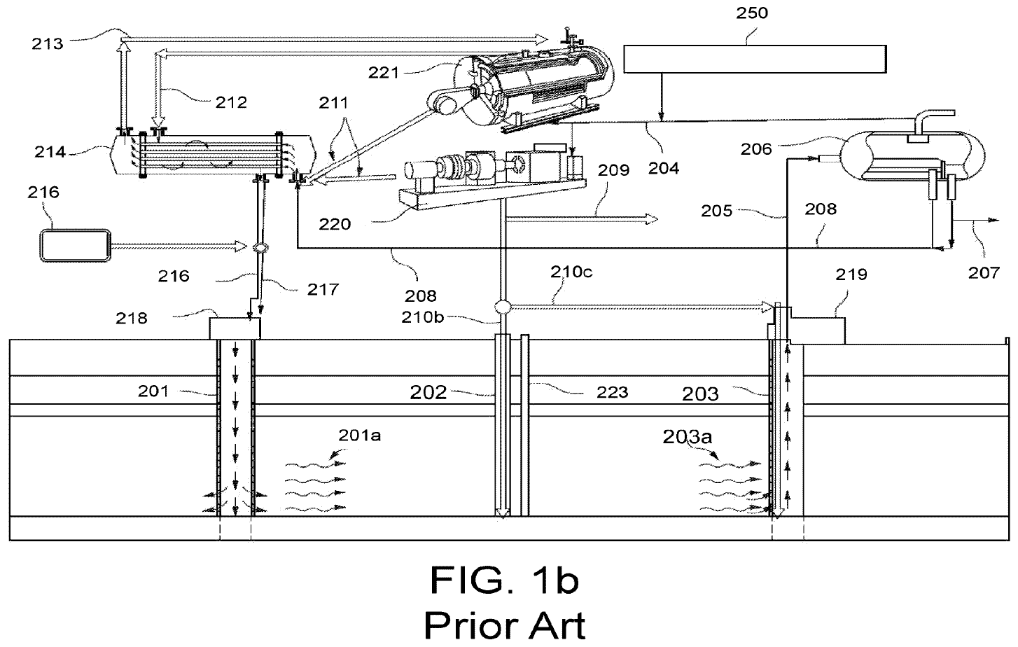

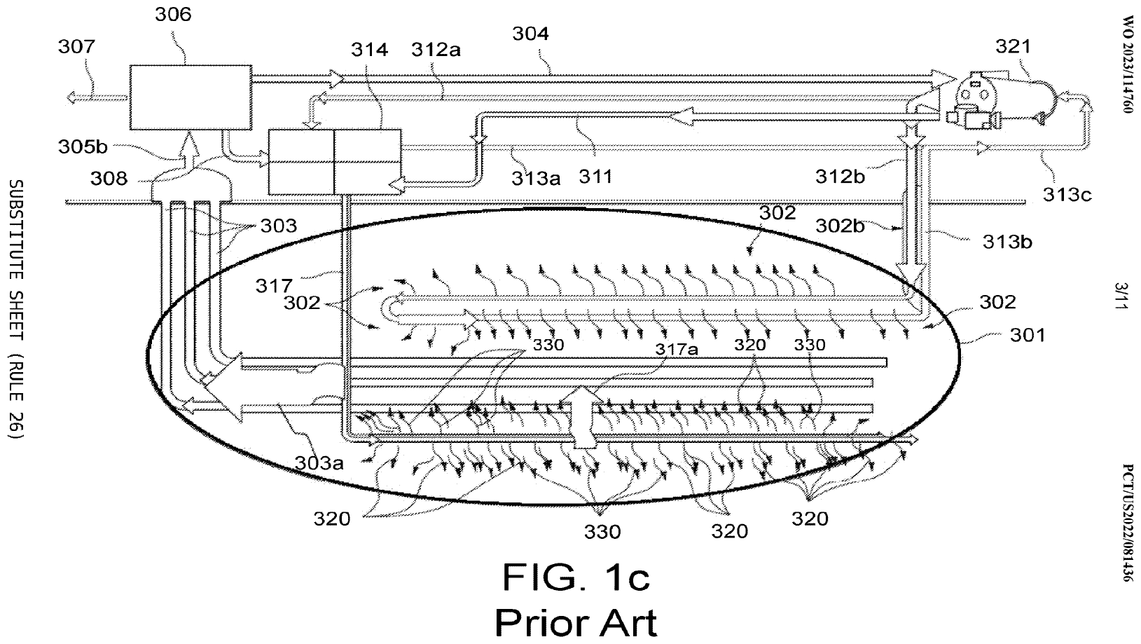

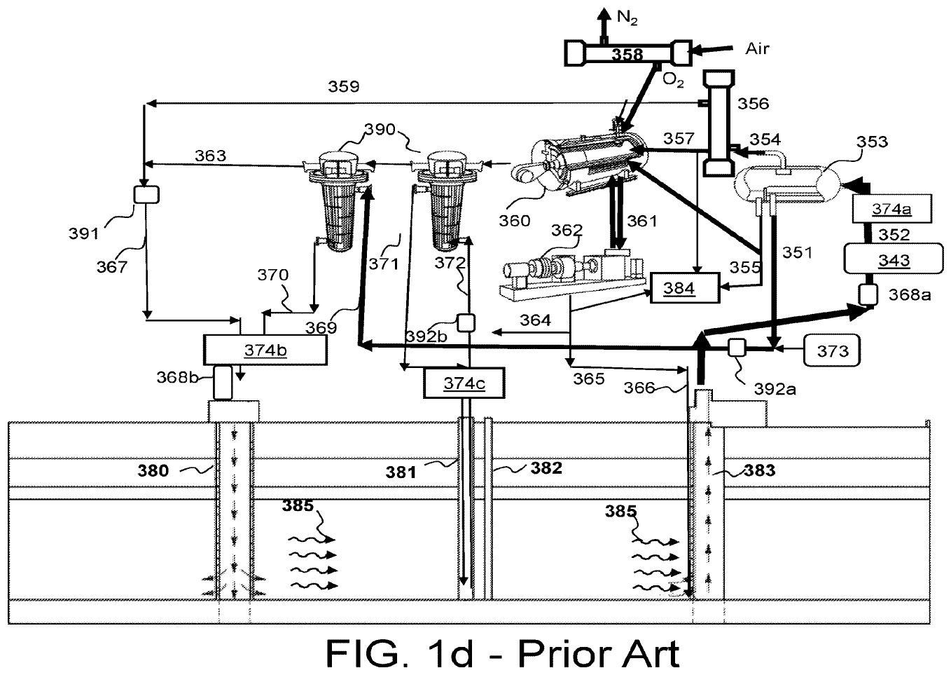

A first example of a comprehensive energy system 500a is shown in FIG. 2. The comprehensive energy system 500a has similarities to the systems described above and shown in FIGS. 1a-1c. However, the present application presents several improvements and modifications to these systems, and incorporates the comprehensive energy systems described herein into energy intensive manufacturing and agricultural environments, among other applications.

The comprehensive energy system 500a in FIG. 2 includes several elements, including a hydrocarbon production system 501 configured for recovery of oil and gas, comprising one or more production wells having submersible pumps (not shown) configured to pump oil, natural gas and/or brine 507a from a reservoir 507b, and one or more oscillators (not shown) that create pull pulses from the reservoir 507b, and which create low pressure in the reservoir 507b that creates flow to the production well of the hydrocarbon production system 501. The hydrocarbon production system 501 also comprises injection wells and heat delivery wells (not shown) configured to increase the productivity of the one or more production wells in the ways described above in reference to FIGS. 1a-1c.

Additionally, the hydrocarbon production system 501 comprises a separator 508 that separates the oil, natural gas, and brine 507a recovered from the reservoir 507b by the production wells. Separated oil 510a flows to an oil storage 509c of a central processing plant. Some of the oil 510a can also be sent to a topping plant 509a for the creation of refined products. The residue from the topping plant 509a can be fed to an emulsifier 509b, which produces an emulsified oil 510c, that can be used by electric turbines 519 to generate electricity. Separated natural gas 510b and/or emulsified oil 510c flows to the electricity generation system 502 for the generation of clean electricity. If there is an excess of natural gas, it may be sold or used to generate electricity for sale.

The comprehensive energy system 500a also comprises an electricity generation system 502 that is configured to generate electricity by way of electricity generating turbines 519. The turbines 519 are further configured to generate heat and exhaust that is processed by a heat exchanger 513 and a gas separator 518a for use by the comprehensive energy system 500a. It is to be understood that while FIG. 2 shows the heat exchanger 513 and gas separator 518a as components of the electricity generation system 502, the heat exchanger 513 and gas separator 518a may be located separately or externally from the electricity generation system 502 and/or turbines 519.

Separated brine 512a can flow to the heat exchanger 513. If water is required for the emulsifier 509b, a portion of the brine 512a can be treated and delivered to the emulsifier 509b for use by the emulsifier 509b.

Extracted natural gas 510b from the separator 508 and/or emulsified oil 510c from the emulsifier 509b is burned by electric turbines 519 to generate electricity 511a, 511b, 511c. The electric turbines 519 can be implemented in 5 MW (or larger) modules and are completely expandable, and may be steam or gas turbines. Some or all of the electricity 511a generated can then be used operate the components of comprehensive energy system 500a, including the hydrocarbon production system 501 and electricity generation system 502, including the wells, pumps, heating elements, control devices, and any other electronic devices required therein. If more electricity is generated than is required by the comprehensive energy system 500a, excess electricity 511c can be sold to a grid 503 or electricity 511b can be provided to external facilities 505 for further use by the facilities 505, such as data centers, wastewater treatment centers, green bulk hydrogen generation, and/or smart cities. If the amount of electricity to be generated by the electric turbines 519 requires more than amount of gas 510b than was extracted, an optional external gas supply 506 or emulsified oil 510c can be used.

The hot exhaust 514a from the electric turbines 519 flows into the heat exchanger 513. The brine 512a from the separator 508 and the exhaust 514a from the electric turbine 519, which can be greater than >500° C., flows into the heat exchanger 513. The thermal energy from the exhaust 514a is transferred to the brine 512a in the heat exchanger 513, and the hot brine 512b flows to the injection wells and the heat delivery wells of the hydrocarbon production system 501.

A gas separator 518a for separating different gases in the exhaust gas 514a may also be provided. Cooled exhaust gas 514b, after transferring heat to the brine 512a, is provided from the heat exchanger 513 to the gas separator 518a. Approximately 78% of air input to the gas separator 518a is nitrogen. Nitrogen 515 is separated from the exhaust 514b of the electric turbines 519 by the gas separator 518a and can be stored, sold or provided for other uses. Oxygen 516 is also separated from the exhaust 514b and separated, highly concentrated oxygen 516 can be fed back into the electric turbine 519 for injection into the electric turbine 519, or can be stored, sold or provided for other uses. The gas separator 518a also separates out carbon dioxide 514c from the exhaust 514b. The cooled carbon dioxide exhaust gas 514c from the gas separator 518a is injected by injection wells of the hydrocarbon recovery system 501 into the reservoir 507b and sequestered, creating a carbon dioxide flood to increase production from the reservoir 507.

The hydrocarbon production system 501 comprises injection wells (not shown), which comprise a pump and oscillator for the brine 512b. The pump creates the necessary pressure, and the oscillator creates the pulses. Examples of such oscillators can be found and are described in applicant's International Application PCT/US22/45009, which is hereby incorporated by reference in its entirety. A compressor creates pressure for the injection of exhaust gases and carbon dioxide 514c into the reservoir 507b. Injectors create high pressure zones in the reservoir 507b that directionally mobilizes the hydrocarbons 507a to move toward the lower pressure zones created by the production wells. Heat wells pump hot brine 512b into the reservoir 507b, including at a 90-degree angle, to create low viscosity paths of least resistance. This allows the comprehensive energy system 500a to volumetrically extract hydrocarbons 507a, where the injection wells may be approximately five hundred twenty five feet from the production wells.

The comprehensive energy system 500a may also comprise a micro grid (not shown), which manages the electricity 511a-511c generated and supplies the electricity for local users, which includes operations of the hydrocarbon production system 501 and electricity generation system 502. The micro grid also manages the supply of any electricity 511b, 511c sold or supplied to the grid 503.

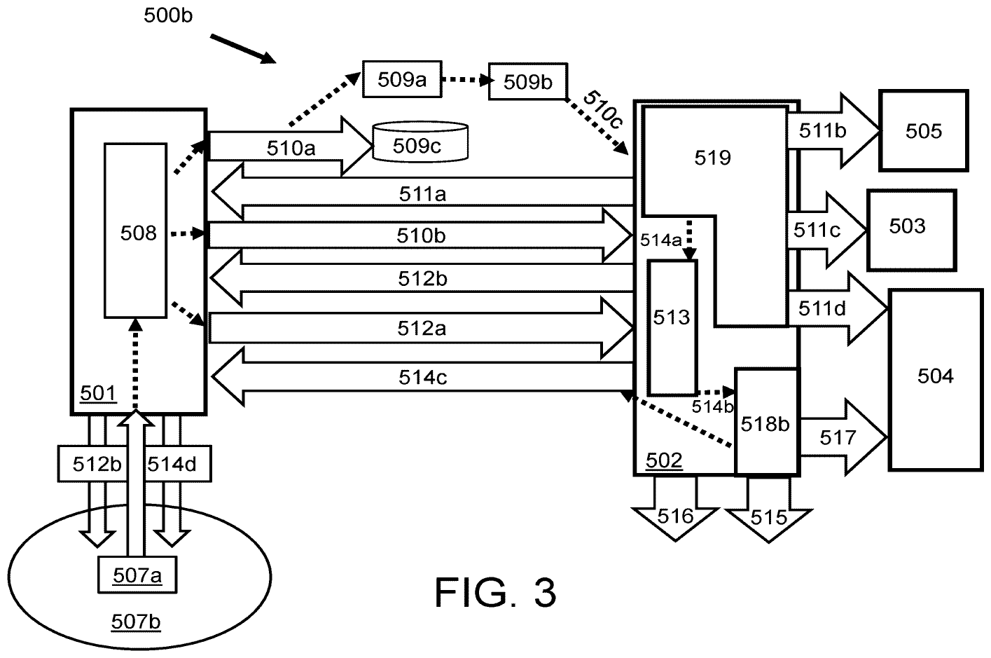

A further example of a comprehensive energy system 500b according to the present application is shown in FIG. 3. The comprehensive energy system 500b can be used for various applications, including for example, crop stimulation. Fuel choices the electricity generation system 502 for the comprehensive energy system 500b may include oil and/or gas, including oil and/or gas recovered from the reservoir 507b. The electric turbines 519 of the comprehensive energy system 500b may be gas or steam powered.

The comprehensive energy system 500b may include many of the same elements as those comprised by the comprehensive energy system 500a of FIG. 2. However, the comprehensive energy system 500b includes a modified gas separator 518b from the gas separator 518a of FIG. 2. The gas separator 518b is configured to separate carbon dioxide, oxygen, but output separated carbon dioxide 514c for sequestration 514d, and also output carbon dioxide with nitrogen 517 for external use. The carbon dioxide and nitrogen 517 can be delivered to greenhouses 504 and used for crop stimulation (carbon dioxide capture using photosynthesis), or may be delivered to other crop growing environments outside of a greenhouse. Crop stimulation can increase crop yield by 30-60%. Any separated carbon dioxide not used for crop stimulation may be sold or added to the carbon dioxide 514d that is sequestered underground. Electricity 511d generated by the electric turbines 519 is also supplied to the greenhouses 504 to meet electric needs of the greenhouses 504.

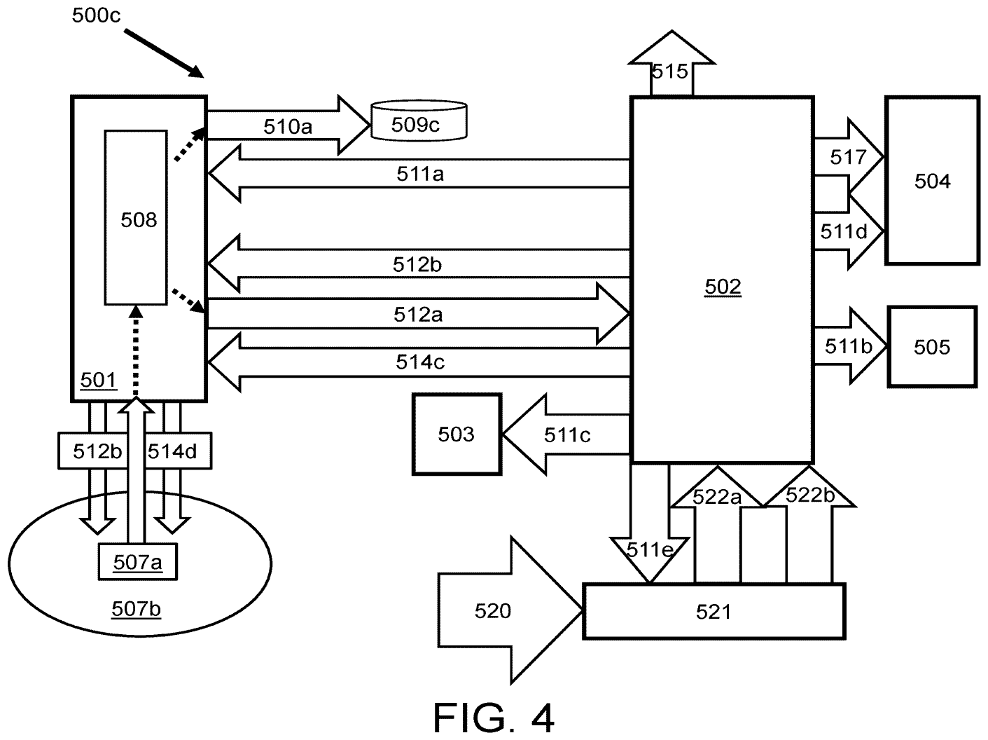

A further example of a comprehensive energy system 500c according to the present application is shown in FIG. 4. In the comprehensive energy system 500c, the fuel utilized by the electricity generation system 502 is waste 520 (i.e., biomass recovered from garbage) to provide a waste to energy system 521. Waste 520 may come from refuse, garbage, or trash systems, public or private. Prior to combustion, the waste 520 to remove metals and plastics, so that the waste 520 provided for combustion is only biomass. The waste to energy system 521 can include a burner, furnace or kiln that burns waste 520 and provides waste heat 522a and waste exhaust 522b to the electricity generation system 502, where the waste heat 522a and the waste exhaust 522b is used for electric generation by steam turbines 519, and for heating brine 512a by the heat exchanger 513. The waste to energy system 521 provides low electricity costs, net zero emissions with no carbon dioxide emissions and allows income from garbage disposal by converting the waste 520 to electricity generated by the electricity generation system 502. Electricity 511e generated by the steam turbines 519 can be supplied back to the waste to energy system 521 for powering the components thereof.

It is noted that for ease of illustration, the heat exchanger 513, gas separator 518b, and turbines 519 are not identified in FIG. 4 as in FIGS. 2 and 3, but it is to be understood that these components are provided in the comprehensive energy system 500c, as previously described.

In the comprehensive energy system 500c of FIG. 4, the separator 508 separates the oil, gas, and brine 507a, and oil 510a flows to the oil storage 509c for sale to the market. Optionally, some of the oil 510a can be sent to a topping plant 509a for the creation of refined products. The residue from the topping plant 509a can be fed to an emulsifier 509b which produces an emulsified oil 510c. The emulsified oil 510c can be used by the electricity generation system 502 to generate electricity.

Further in the comprehensive energy system 500c, municipal waste 520, and optionally other waste, is burned by the waste to energy system 521 to generate heat 522a used in generating steam for the steam turbines 519. If gas is extracted from the reservoir 507b and is not sold, it can be used in burning the waste 520 by waste to energy system 521 to avoid flaring the gas. The waste heat 522a and hot exhaust 522b (including carbon dioxide exhaust) generated by the waste to energy system 521 are transferred to the electricity generation system 502 for processing, where they are used by the steam turbines 519 and in heating the brine 512a by the heat exchanger 513. If water is required for the emulsifier 509b, a portion of the brine 512a can treated and used therein. The comprehensive energy system 500b of FIG. 3 can also be implemented in combination with the comprehensive energy system 500c of FIG. 4.

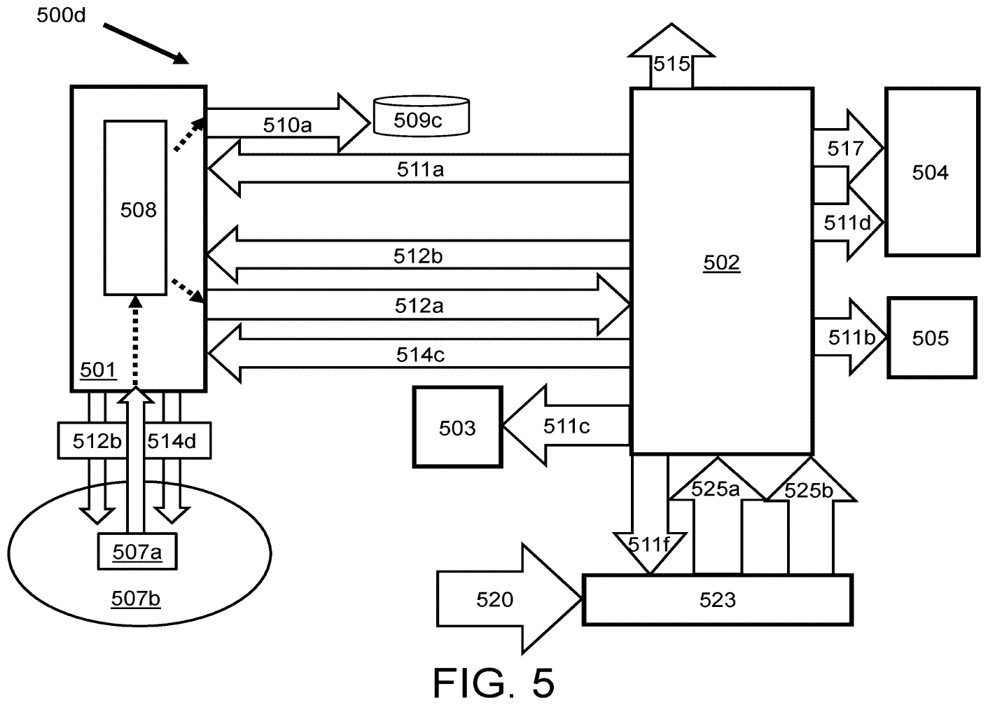

A further example of a comprehensive energy system 500d for using waste heat and carbon dioxide to support energy intensive manufacturing according to the present application is shown in FIG. 5. In the comprehensive energy system 500d, the fuel utilized by the electricity generation system 502 is waste 520, as previously described, and a manufacturing facility 523 is provided, which includes a waste to energy system (not shown) therein or in conjunction therewith, similar to the waste to energy system 521 shown in FIG. 4 for combusting waste 520. The manufacturing facility 523 may include a burner, furnace or kiln that burns waste 520 and generates waste heat 525a and waste exhaust 525b for electric generation by steam turbines 519 and heating brine 512a by heat exchangers 513, while also providing thermal energy for use by the manufacturing facility 523 in manufacturing processes, such as fueling furnaces for manufacturing, providing heat for manufacturing processes, or providing thermal energy to steam turbines for generating electricity used by the manufacturing facility 523. This provides low electricity costs, net zero emissions with no carbon dioxide emissions and allows income from garbage disposal by converting the waste to electricity. It is noted that for ease of illustration, the heat exchanger 513, gas separator 518b, and turbines 519 are not identified in FIG. 5 as in FIGS. 2 and 3, but it is to be understood that these components are provided in the comprehensive energy system 500d.

In the comprehensive energy system 500d of FIG. 5, the separator 508 separates the oil, gas and brine 507a, and oil 510a flows to the oil storage 509c for sale to the market. Optionally, some of the oil 510a can be sent to a topping plant 509a for the creation of refined products. The residue from the topping plant 509a can be fed to an emulsifier 509b which produces an emulsified oil 510c. The emulsified oil 510c can be used by the electricity generation system 502 to generate electricity.

The waste 520 burned in the comprehensive energy system 500d of FIG. 5 for electricity generation is increased in comparison to the comprehensive energy system 500c of FIG. 4, and the waste 520 is burned to generate heat for the steam turbines 519 and thermal energy for the manufacturing facility 523. Carbon dioxide exhaust 525b and excess waste heat 525a (not utilized by the manufacturing facility 523) from the manufacturing facility 523 and the waste combustion is transferred to the electricity generation system 502 for processing, where they are used by the steam turbines 519 and by the heat exchanger 513 heating the brine 512a. If gas is extracted from the reservoir 507b and is not sold, it can be used in burning the waste 520 by the waste to energy system to avoid flaring the gas. If water is required for the emulsifier 509b, a portion of the brine 512a can treated and used therein. The comprehensive energy systems 500b, 500c, in FIGS. 3 and 4 can be implemented with the comprehensive energy system 500d of FIG. 5.

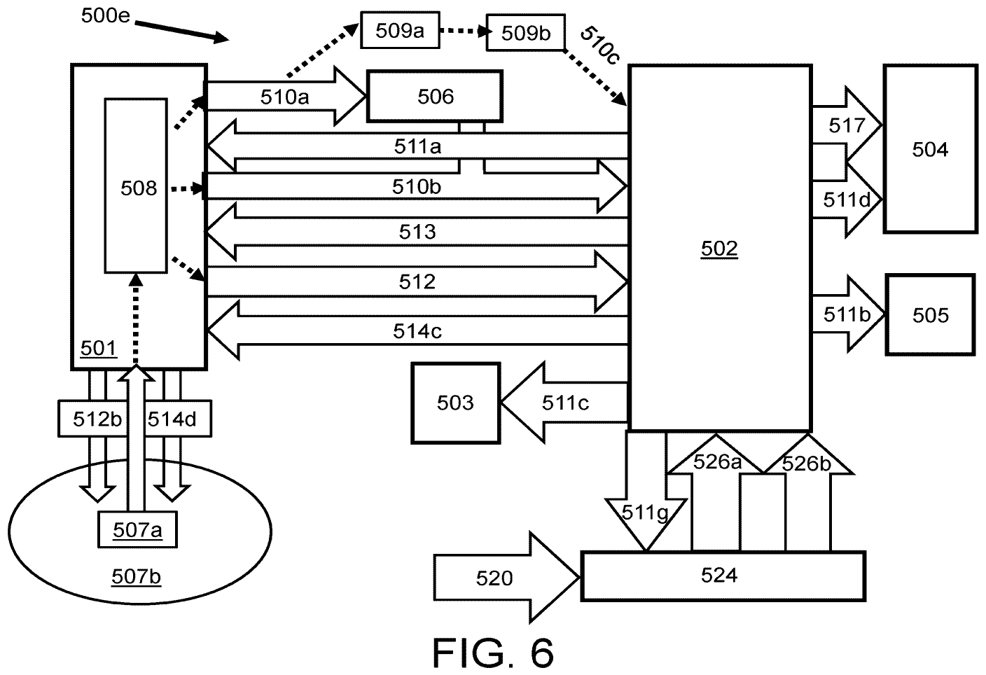

A further example of a modified comprehensive energy system 500e according to the present application is shown in FIG. 6. In the comprehensive energy system 500e, combustion of waste 520 used to support energy intensive manufacturing operations in cement plants 524. It is noted that for ease of illustration, the heat exchanger 513, gas separator 518b, and turbines 519 are not identified in FIG. 6 as in FIGS. 2 and 3, but it is to be understood that these components are provided in the comprehensive energy system 500e.

In the comprehensive energy system 500e of FIG. 6, the separator 508 separates the oil, gas and brine 507a, and oil 510a flows to the oil storage 509c for sale to the market. Optionally, some of the oil 510a can be sent to a topping plant 509a for the creation of refined products. The residue from the topping plant 509a can be fed to an emulsifier 509b which produces an emulsified oil 510c. The emulsified oil 510c can be used by the electricity generation system 502 to generate electricity.

The waste 520 burned in the comprehensive energy system 500e of FIG. 6 for electricity generation is increased in comparison to the comprehensive energy system 500c of FIG. 4, and the waste 520 is burned to generate heat for the steam turbines 519 and thermal energy for the kiln of the cement plant 524. Carbon dioxide exhaust 526b and excess waste heat 526a (not utilized by the manufacturing facility 523) from the cement plant 524 and the waste combustion is transferred to the electricity generation system 502 for processing, where they are used generating steam for the turbines 519 and by the heat exchanger 513 in heating the brine 512a. If gas is extracted from the reservoir 507b and is not sold, it can be used in burning the waste 520 by waste to energy system 521 to avoid flaring the gas. If water is required for the emulsifier 509b, a portion of the brine 512a can treated and used therein. The comprehensive energy systems 500b, 500c in FIGS. 3 and 4 can be implemented with the comprehensive energy system 500e of FIG. 6.

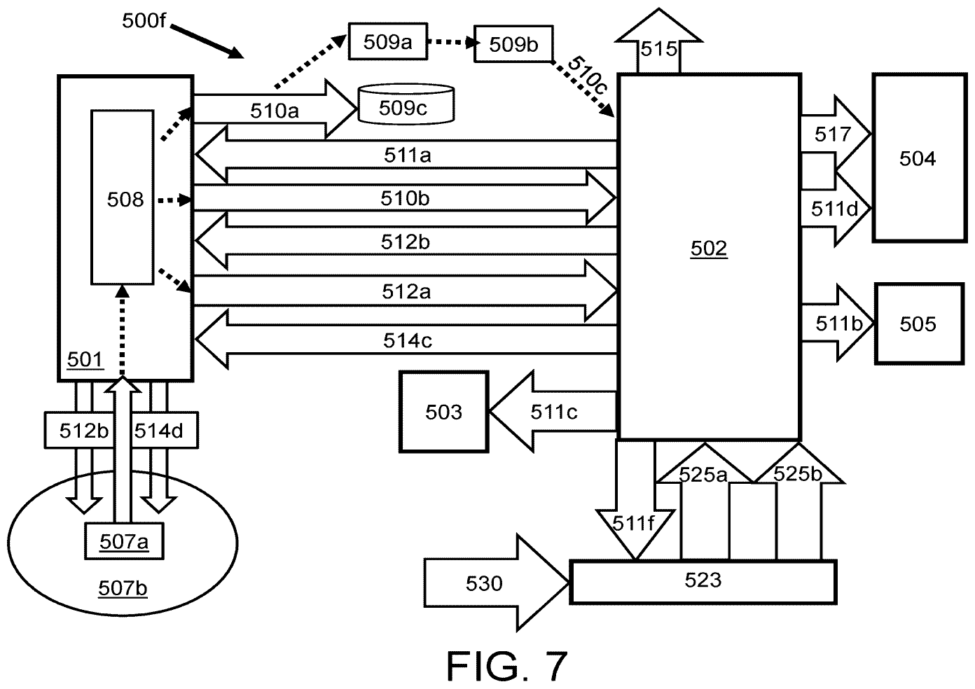

A further example of a comprehensive energy system 500f according to the present application is shown in FIG. 7. In the comprehensive energy system 500f, coal or coke 530 is used as the fuel source to support energy intensive manufacturing at a manufacturing facility 523. It is also noted that the comprehensive energy system 500f of FIG. 7 can be used with a cement plant 524 in place of a manufacturing facility 523.

It is noted that for ease of illustration, the heat exchanger 513, gas separator 518b, and turbines 519 are not identified in FIG. 7 as in FIGS. 2 and 3, but it is to be understood that these components are provided in the comprehensive energy system 500f.

In the comprehensive energy system 500f of FIG. 7, the separator 508 separates the oil, gas and brine 507a, and oil 510a flows to the oil storage 509c for sale to the market. Optionally, some of the oil 510a can be sent to a topping plant 509a for the creation of refined products. The residue from the topping plant 509a can be fed to an emulsifier 509b which produces an emulsified oil 510c. The emulsified oil 510c can be used by the electricity generation system 502 to generate electricity.

Coal or coke 530 are burned for electricity generation and to generate heat for the steam turbines 519 and thermal energy for the manufacturing facility 523, or alternatively for the kiln of the cement plant or other energy intensive applications. Carbon dioxide exhaust 525b and excess waste heat 525a (not utilized by the manufacturing facility 523) from the manufacturing facility 523 and the waste combustion is transferred to the electricity generation system 502 for processing, where they are used by the steam turbines 519 and by the heat exchanger 513 heating the brine 512a. If gas is extracted from the reservoir 507b and is not sold, it can be used in burning the waste 520 by the waste to energy system to avoid flaring the gas. If water is required for the emulsifier 509b, a portion of the brine 512a can treated and used therein. The comprehensive energy systems 500b, 500c in FIGS. 3 and 4 can be implemented with the comprehensive energy system 500f of FIG. 7.

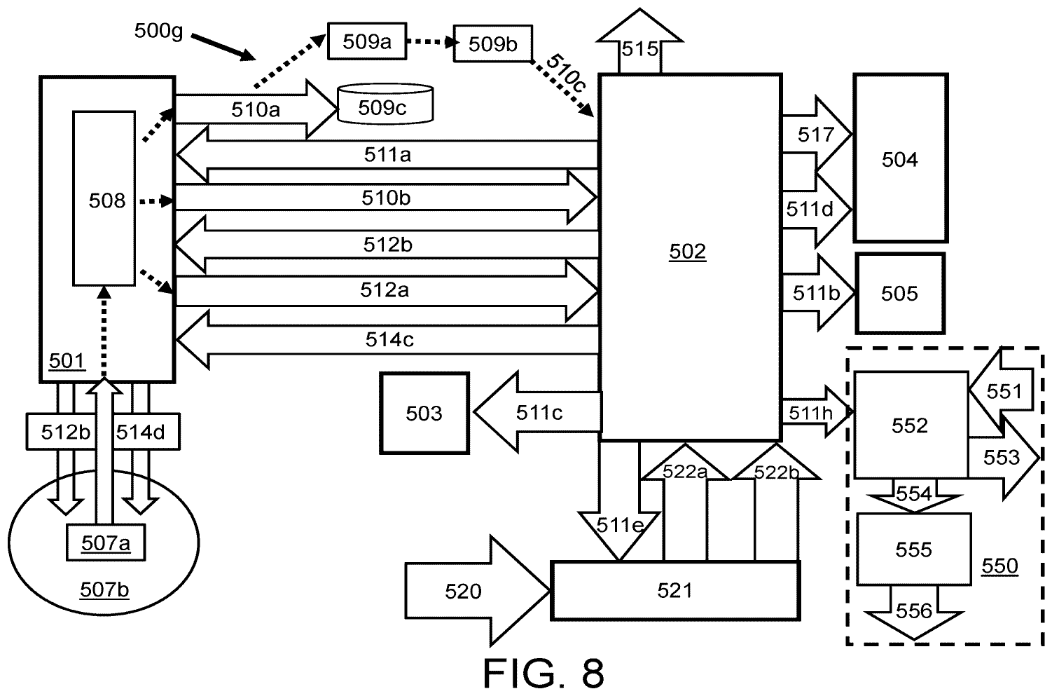

A further example of a modified comprehensive energy system 500g according to the present application is shown in FIG. 8. In this comprehensive energy system 500g, waste 520 is used to support green bulk hydrogen processing by a hydrogen generating system 550. Other fuel sources can be used in the comprehensive energy system 500g.

It is noted that for ease of illustration, the heat exchanger 513, gas separator 518b, and turbines 519 are not identified in FIG. 8 as in FIGS. 2 and 3, but it is to be understood that these components are provided in the comprehensive energy system 500g.

In the comprehensive energy system 500g of FIG. 8, the separator 508 separates the oil, gas and brine 507a, and oil 510a flows to the oil storage 509c for sale to the market. Optionally, some of the oil 510a can be sent to a topping plant 509a for the creation of refined products. The residue from the topping plant 509a can be fed to an emulsifier 509b which produces an emulsified oil 510c. The emulsified oil 510c can be used by the electricity generation system 502 to generate electricity.

The waste 520 burned in the comprehensive energy system 500g of FIG. 8 for electricity generation is increased in comparison to the comprehensive energy system 500c of FIG. 4 and is burned to generate heat for the steam turbines 519, which also provide electrical energy 511h for the green bulk hydrogen generation by a hydrogen generating system 550 using electrolysis. The hydrogen generating system 550 comprises an electrolysis device 552 that is powered by electricity 511h generated by the electricity generation system 502. The electrolysis device 552 receives water 551, which undergoes electrolysis, and outputs oxygen 553 and hydrogen 554. The hydrogen 554 can be provided to a hydrogen storage unit 555 for further delivery 556.

If gas is extracted from the reservoir 507b and is not sold, it can be used in burning the waste 520 by waste to energy system 521 to avoid flaring the gas The waste heat 522a and hot exhaust 522b (including carbon dioxide exhaust) generated by the waste to energy system 521 are transferred to the electricity generation system 502 for processing, where they are used by the steam turbines 519 and in heating the brine 512a by the heat exchanger 513. The comprehensive energy systems 500b, 500c in FIGS. 3 and 4 can be implemented with the comprehensive energy system 500g of FIG. 8.

It should be understood that, unless stated otherwise herein, any of the features, characteristics, alternatives or modifications described regarding a particular embodiment herein may also be applied, used, or incorporated with any other embodiment described herein. Also, the Figures herein are not drawn to scale. Although the invention has been described and illustrated with respect to exemplary embodiments thereof, the foregoing and various other additions and omissions may be made therein and thereto without departing from the spirit and scope of the present invention.

1. A system comprising:
a hydrocarbon production system configured to recover hydrocarbons from an underground reservoir;
an electricity generation system comprising one or more turbines configured to generate electricity and heated turbine exhaust gases;
a heat exchanger configured to receive the heated turbine exhaust gases from the one or more turbines and transfer heat from the heated turbine exhaust gases to a fluid, and configured to output a heated fluid and cooled turbine exhaust gases;
a gas separator configured to receive the cooled turbine exhaust gases and separate gases in the cooled turbine exhaust gases; and
a fuel source configured to provide hydrocarbon fuel or thermal energy for powering the one or more turbines of the electricity generation system.

2. The system according to claim 1, wherein the hydrocarbon production system comprises one or more production wells configured to recover the hydrocarbons from the underground reservoir, and wherein the hydrocarbons recovered by the one or more production wells comprise oil and/or natural gas, and the one or more production wells are further configured to recover brine from the underground reservoir with the hydrocarbons recovered; and
wherein the hydrocarbon production system further comprises a separator configured to separate oil, natural gas and brine recovered by the one or more production wells.

3. (canceled)

4. The system according to claim 2, wherein the separator is configured to supply separated brine to the heat exchanger.

5. The system according to claim 2, wherein the separator is configured to supply separated oil to an emulsifier configured to produce emulsified oil, and wherein the emulsified oil is provided to the one or more turbines as the fuel source.

6. The system according to claim 2, wherein the separator is configured to supply separated oil to the one or more turbines as the fuel source.

7. The system according to claim 4, wherein the hydrocarbon production system further comprises:
one or more heat delivery wells configured to supply a heated substance to the underground reservoir; and
one or more injection wells configured to inject a gas into the underground reservoir.

8. The system according to claim 7, wherein the heat exchanger is configured to output heated brine as the heated fluid and provide the heated brine to the one or more heat delivery wells configured to supply the heated brine to the underground reservoir.

9. The system according to claim 7, wherein the gas separator is configured to separate carbon dioxide from the cooled turbine exhaust gases and provide at least a portion of the separated carbon dioxide to the one or more injection wells configured to inject the separated carbon dioxide into the underground reservoir.

10. The system according to claim 1, wherein the electricity generation system is configured to provide electricity for powering electrical components of the hydrocarbon production system.

11. The system according to claim 1, wherein the electricity generation system is further configured to provide electricity to a grid or an external facility consuming the electricity.

12. The system according to claim 11, wherein the external facility is a data center.

13. The system according to claim 1, wherein the electricity generation system is further configured to provide electricity to power an electrolysis device of a hydrogen generation system, the electrolysis device configured to subject water to an electrolysis process to create hydrogen and oxygen.

14. The system according to claim 1, further comprising:
a crop or plant growth system, wherein the electricity generation system is further configured to provide electricity to the crop or plant growth system.

15. The system according to claim 14, wherein the gas separator is configured to: separate oxygen gas, carbon dioxide gas, and nitrogen gas from the cooled turbine exhaust gases; and provide at least a portion of the separated carbon dioxide gas and separated nitrogen gas to the crop or plant growth system for stimulation of crop or plant growth.

16. (canceled)

17. The system according to claim 1, wherein the gas separator is configured to:
separate oxygen gas from the cooled turbine exhaust gases; and
provide at least a portion of the separated oxygen gas to the one or more turbines.

18. The system according to claim 1, wherein the fuel source comprises an external combustion system configured to burn a fuel input to provide thermal energy for powering the one or more turbines of the electricity generating system.

19. The system according to claim 18, wherein the external combustion system is further configured to provide heated exhaust gas to the one or more turbines and/or the heat exchanger.

20. The system according to claim 19, wherein the one or more turbines are steam powered turbines; and wherein the external combustion system comprises a furnace or burner configured to combust biomass waste as the fuel input and is configured to provide thermal energy from the biomass waste combustion to the one or more turbines for heating fluid to generate steam for the one or more turbines.

21. The system according to claim 20, wherein the biomass waste combustion further provides heated waste exhaust gases to the heat exchanger for the transfer of heat from the heated waste exhaust gases to the fluid, and/or to the one or more turbines for heating fluid to generate steam for the one or more turbines.

22. The system according to claim 20, further comprising:
a manufacturing facility comprising the external combustion system, wherein the furnace or burner configured to combust the biomass waste is a furnace or burner used in a manufacturing process at the manufacturing facility; and
wherein the electricity generation system is configured to generate electricity supplied to the manufacturing facility.

23. The system according to claim 20, further comprising:
a cement manufacturing facility comprising the external combustion system, wherein the furnace or burner is a kiln configured to combust the biomass waste in the generation of cement; and wherein the electricity generation system is configured to generate electricity supplied to the cement manufacturing facility.

24. The system according to claim 19, wherein the one or more turbines are steam powered turbines; and wherein the external combustion system comprises a furnace or burner configured to combust one or more of coal, coke, or natural gas as the fuel input and is configured to provide thermal energy from the external combustion system to the one or more turbines for heating fluid to generate steam for the one or more turbines and heated combustion exhaust gases to the heat exchanger for the transfer of heat from the heated combustion exhaust gases to the fluid, and/or to the one or more turbines for heating fluid to generate steam for the one or more turbines.

25. The system according to claim 24, further comprising:
a manufacturing facility comprising the external combustion system, and wherein the furnace or burner configured to combust the coal, coke, or natural gas is a furnace or burner used in a manufacturing process at the manufacturing facility; and
wherein the electricity generation system is configured to generate electricity supplied to the manufacturing facility.

26. The system according to claim 24, further comprising:
a cement manufacturing facility comprising the external combustion system, and wherein the furnace or burner is a kiln configured to combust coal, coke, or natural gas in the generation of cement; and wherein the electricity generation system is configured to generate electricity supplied to the cement manufacturing facility.

27. The system according to claim 8, further comprising:
a crop or plant growth system;
wherein the gas separator is configured to separate oxygen gas, carbon dioxide gas, and nitrogen gas from the cooled turbine exhaust gases, and provide at least a portion of the separated carbon dioxide gas and separated nitrogen gas to the crop or plant growth system for stimulation of crop or plant growth, and provide at least a portion of the separated carbon dioxide to the one or more injection wells configured to inject the separated carbon dioxide into the underground reservoir;
wherein the fuel source comprises an external combustion system configured to burn a fuel input to provide thermal energy for powering the one or more turbines of the electricity generating system, and configured to provide heated exhaust gas to the one or more turbines and/or the heat exchanger;
wherein the one or more turbines are steam powered turbines;
wherein the external combustion system comprises a furnace or burner configured to combust biomass waste as the fuel input and is configured to provide thermal energy from the biomass waste combustion to the one or more turbines for heating fluid to generate steam for the one or more turbines and provide heated waste exhaust gases to the heat exchanger for the transfer of heat from the heated waste exhaust gases to the fluid, and/or to the one or more turbines for heating fluid to generate steam for the one or more turbines; and
wherein the electricity generation system is configured to provide: electricity for powering electrical components of the hydrocarbon production system, electricity to a grid or an external facility consuming the electricity, and electricity to the crop or plant growth system.

28. The system according to claim 27, further comprising:
a manufacturing facility comprising the external combustion system, and wherein the furnace or burner configured to combust the biomass waste is a furnace or burner used in a manufacturing process at the manufacturing facility; and
wherein the electricity generation system is configured to generate electricity supplied to the manufacturing facility.

29. The system according to claim 27, further comprising:
a cement manufacturing facility comprising the external combustion system, and wherein the furnace or burner is a kiln configured to combust the biomass waste in the generation of cement; and
wherein the electricity generation system is configured to generate electricity supplied to the cement manufacturing facility.

30. The system according to claim 28, wherein the electricity generation system is further configured to provide electricity to power an electrolysis device of a hydrogen generation system, the electrolysis device configured to subject water to an electrolysis process to create hydrogen and oxygen.

31. A method comprising:
recovering hydrocarbons from an underground reservoir by a hydrocarbon production system;
providing a fuel source for powering one or more turbines of an electricity generation system;
generating electricity and heated turbine exhaust gases from the electricity generation system;
receiving, by a heat exchanger, the heated turbine exhaust gases;
transferring, by the heat exchanger, heat from the heated turbine exhaust gases to a fluid, outputting, by the heat exchanger, a heated fluid and cooled turbine exhaust gases;
receiving, by a gas separator, the cooled turbine exhaust gases; and
separating, by the gas separator, gases in the cooled turbine exhaust gases.

32.-60. (canceled)
